(19) United States
(12) Patent Application Publication
(10) Pub. No.: US 2022/0294929 A1
(43) Pub. Date: Sep. 15, 2022

(54) INFORMATION PROCESSING SYSTEM, INFORMATION PROCESSING APPARATUS, RECORDING MEDIUM, AND METHOD

(71) Applicant: Keiichiro HITOMI, Tokyo (JP)

(72) Inventor: Keiichiro HITOMI, Tokyo (JP)

(73) Assignee: Ricoh Company, Ltd., Tokyo (JP)

(21) Appl. No.: 17/652,182

(22) Filed: Feb. 23, 2022

(30) Foreign Application Priority Data
Mar. 11, 2021 (JP) 2021-039133

(51) Int. Cl. H04N 1/44; H04N 1/00; H04L 9/40

(52) U.S. Cl. CPC H04N 1/4433; H04N 1/4426; H04N 1/00244; H04N 1/4413; H04L 63/083; H04N 2201/0094

(57) ABSTRACT

An information processing system includes an information processing apparatus including a first processor and a first memory storing first program instructions and includes an information processing server including a second processor and a second memory storing second program instructions that cause the second processor to authenticate a user logging in to the information processing apparatus, wherein the first program instructions cause the first processor to log in the user as a guest user when the information processing server is not usable by the information processing apparatus.

### CROSS-REFERENCE TO RELATED APPLICATION

The present application is based on and claims priority under 35 U.S.C. § 119 to Japanese Patent Application No. 2021-039133, filed on Mar. 11, 2021, the content of which is incorporated herein by reference in its entirety.

### BACKGROUND OF THE INVENTION

An embodiment of the present disclosure relates to an information processing system, an information processing apparatus, a recording medium, and a method.

### DESCRIPTION OF RELATED ART

Conventionally a technique is known in which authentication of a user is performed by an authentication server on cloud or on premise, instead of by an information processing apparatus such as, for example, an image forming apparatus (for example a multifunction peripheral/printer/product (MFP)) when the user is logging in to the information processing apparatus.

### CITATION LIST

### Patent Literature

[Patent Document 1] Japanese Unexamined Patent Application Publication No. 2010-277185

### SUMMARY OF THE INVENTION

According to an aspect of an embodiment of the present disclosure, an information processing system includes an information processing apparatus including a first processor and a first memory storing first program instructions, and includes an information processing server including a second processor and a second memory storing second program instructions that cause the second processor to authenticate a user logging in to the information processing apparatus, wherein the first program instructions cause the first processor to log in the user as a guest user when the information processing server is not usable by the information processing apparatus.

### BRIEF DESCRIPTION OF THE DRAWINGS

FIG. 1 is an overall configuration diagram of an information processing system according to an embodiment of the present disclosure;

FIG. 2 is a diagram illustrating a hardware configuration of an information processing apparatus (in the case of an MFP) according to the embodiment of the present disclosure;

FIG. 3 is a diagram illustrating a hardware configuration of an information processing server according to the embodiment of the present disclosure;

FIG. 4 is a diagram illustrating functional blocks of the information processing system according to the embodiment of the present disclosure;

FIG. 5 is an example of setting information according to the embodiment of the present disclosure;

FIG. 6 is a sequence diagram illustrating a processing flow in a case where the information processing server is usable according to the embodiment of the present disclosure;

FIG. 7 is a sequence diagram illustrating a processing flow in a case where the information processing server is not usable according to the embodiment of the present disclosure;

FIG. 8 is an example of a setting screen according to the embodiment of the present disclosure;

FIG. 9 is an example of a screen in a case where the information processing server according to the embodiment of the present disclosure is usable; and

FIG. 10 is an example of a screen in a case where the information processing server according to the embodiment of the present disclosure is not usable.

### DESCRIPTION OF THE EMBODIMENTS

However, in a case where the authentication server is not usable by the information processing apparatus due to there being no network connection or due to the authentication server being down, the user cannot log in to the information processing apparatus.

It is desired to log a user in to the information processing apparatus when the authentication server is not usable by the information processing apparatus.

Herein, an embodiment of the present invention is described with reference to the drawings. In the present specification and the drawings, components having substantially the same functional configuration are referenced by the same reference numeral, and overlapping description is omitted.

### Description of Terms

In the present specification, the term “guest user” refers to an account that is usable by all users and is common to all users when the information processing server 20 (authentication server) is not usable by the information processing apparatus 10. When guest-user login is set as enabled, a user can log in to an information processing apparatus 10 as a guest user and use functions of the information processing apparatus 10 as a guest user while an information processing server 20 is not usable by the information processing apparatus 10.

(System Configuration)

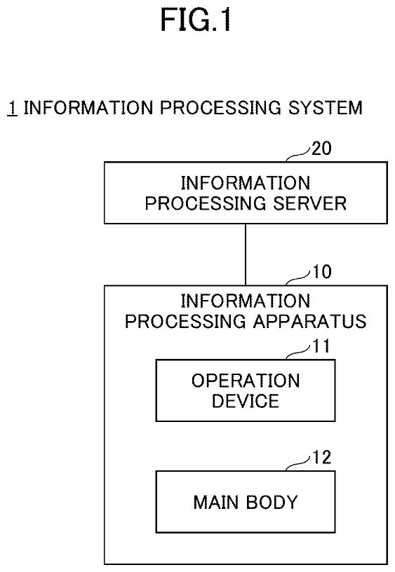

FIG. 1 is an overall configuration diagram of an information processing system 1 according to the embodiment of the present disclosure. As illustrated in FIG. 1, the information processing system 1 includes an information processing apparatus 10 and an information processing server 20. The information processing apparatus 10 and the information processing server 20 can transmit and receive data to and from each other via any network. The aforementioned hardware is described below.

The information processing apparatus 10 is, for example, an image forming apparatus such as an MFP or the like. The information processing apparatus 10 includes an operation device 11 and a main body 12.

As long as the information processing apparatus 10 is an apparatus that has a communication function, the information processing apparatus 10 is not limited to an image forming apparatus such as an MFP or the like. The information processing apparatus 10 may be, for example, an output device such as a projector (PJ), an Interactive White Board (IWB) having an electronic blackboard function enabling mutual communication, or digital signage. The information processing apparatus 10 may be, for example, a Head Up Display (HUD) device, an industrial machine, an imaging element, a sound collector, a medical device, a network home appliance, a connected car, or the like. Further, the information processing apparatus 10 may be a personal computer (PC), a mobile phone, a smartphone a tablet terminal, a game console, a Personal Digital Assistant (PDA), a digital camera a wearable PC, a desktop PC, or the like.

The information processing server 20 is an authentication server that authenticates a user when the user is logging in to the information processing apparatus 10.

The system, apparatuses, and devices used in the Examples are merely an example of one of multiple computing environments for implementing the embodiment disclosed in the present specification. In the embodiment, for example, the information processing server 20 may include multiple computing apparatuses configured as a server cluster. The multiple computing apparatuses are configured to communicate with each other via a communication link of any given type including a network, a shared memory, and to implement the processing disclosed in the present specification.

(MFP Hardware Configuration)

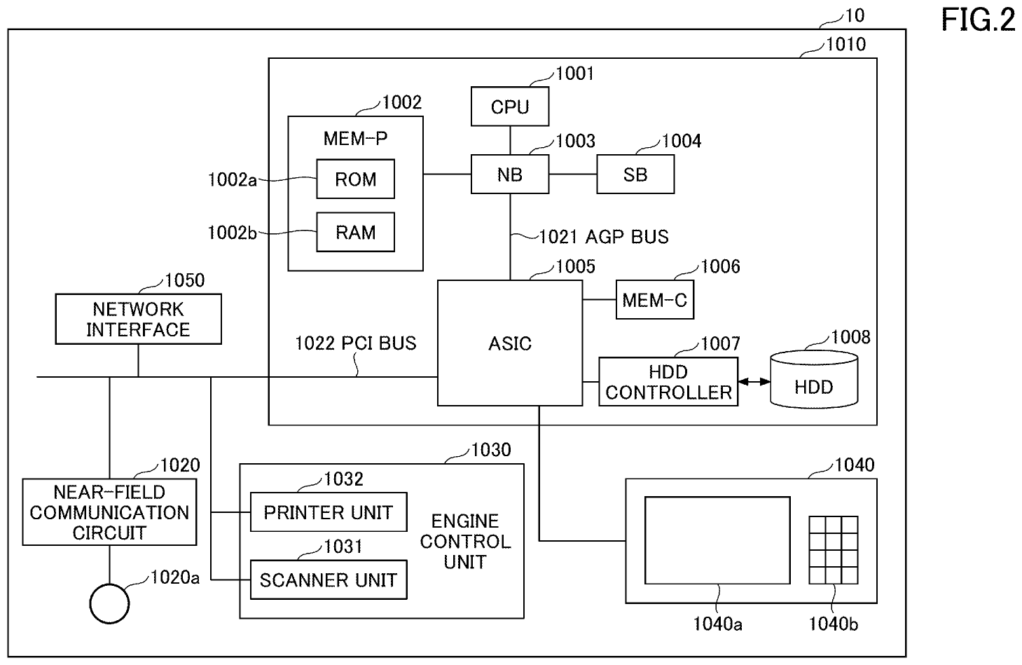

FIG. 2 is a diagram illustrating a hardware configuration of the information processing apparatus (in the case of an MFP) 10 according to the embodiment of the present disclosure.

As illustrated in FIG. 2, the information processing apparatus (in the case of an MFP) 10 includes a controller 1010, a near-field communication circuit 1020, an engine control unit 1030, an operation panel 1040, and a network interface (I/F) 1050.

Among them, the controller 1010 includes a CPU 1001, a system memory (MEM-P) 1002, a northbridge (NB) 1003, a southbridge (SB) 1004, an application specific integrated circuit (ASIC) 1005, a local memory (MEM-C) 1006 that is a storage, a hard disk drive (HDD) controller 1007, a hard disk drive (HDD) 1008 that is a storage, all of which are main components of a computer, and is configured such that the NB 1003 and the ASIC 1005 are connected by an accelerated graphics port (AGP) bus 1021.

Among them, the CPU 1001 is a control unit that controls the entirety of the information processing apparatus (in the case of an MFP) 10. The NB 1003 is a bridge for connecting the CPU 1001, the MEM-P 1002, the SB 1004, and the AGP bus 1021. The NB 1003 includes a memory controller for controlling reading and writing from and to the MEM-P 1002, and also includes a peripheral component interconnect (PCI) master and an AGP target.

The MEM-P 1002 includes a ROM 1002a and a RAM 1002b. The ROM 1002a is a memory for storing programs and data for implementing functions of the controller 1010. The RAM 1002b is used as a memory to which programs and data are extracted and as a rendering memory during memory printing. The programs stored in the RAM 1002b may be provided in a form of an installable or executable file recorded on a computer-readable recording medium such as a CD-ROM, a CD-R, or a DVD.

The SB 1004 is a bridge for connecting the NB 1003 to the PCI devices and peripheral devices. The ASIC 1005 is an integrated circuit (IC) for image processing that has hardware elements for image processing, and serves as a bridge that connects the AGP bus 1021, the PCI bus 1022, the HDD controller 1007, and the MEM-C 1006. This ASIC 1005 includes a PCI target, an AGP master, an arbiter (ARB) that forms the core of the ASIC 1005, a memory controller that controls the MEM-C 1006, and a plurality of Direct Memory Access Controllers (DMACs) that rotate image data using hardware logic and the like, and also includes a PCI unit that performs data transfer between a scanner unit 1031 and a printer unit 1032 via the PCI bus 1022. The ASIC 1005 may be connected to a universal serial bus (USB) interface or an IEEE 1394 (Institute of Electrical and Electronics Engineers 1394).

The MEM-C 1006 is a memory used as an image buffer for copying and as a coder buffer. The HDD 1008 is a storage for storing image data, storing font data used for printing, and storing forms. The HDD controller 1007 controls reading or writing of data from or to the HDD 1008 according to the control of the CPU 1001. The AGP bus 1021 is a bus interface for a graphics accelerator card that has been proposed to speed up graphics processing. The AGP bus 1021 can accelerate the graphics accelerator card by directly accessing the MEM-P 1002 at a high throughput.

The near-field communication circuit 1020 includes a near-field communication circuit 1020a. The near-field communication circuit 1020 is a communication circuit such as NFC (Near Field Communication) and Bluetooth (registered trademark).

Further, the engine control unit 1030 includes the scanner unit 1031 and the printer unit 1032. The operation panel 1040 includes a panel display unit 1040a and an operation panel 1040b. The panel display unit 1040a is, for example, a touch panel and the like for displaying current setting values, a selection screen, and the like, and for receiving an input from a user. The operation panel 1040b includes, for example, numeric keys for receiving setting values of conditions for image forming such as a setting condition of a density, a start key for receiving a copy start instruction, and the like. The controller 1010 controls the entirety of the information processing apparatus (in the case of an MFP) 10 and controls, for example, rendering, communication, input from the operation panel 1040, and the like. The scanner unit 1031 or the printer unit 1032 includes image processing portions for error diffusion, gamma conversion, and the like.

In response to an operation of an application switching key of the operation panel 1040, the information processing apparatus (in the case of an MFP) 10 can sequentially switch and select a document box function, a copy function, a printer function, and a facsimile function. The document box mode is set when the document box function is selected, the copy mode is set when the copy function is selected, the printer mode is set when the printer function is selected, and the facsimile mode is set when the facsimile mode is selected.

The network I/F 1050 is an interface for performing data communication using the communication network. The near-field communication circuit 1020 and the network I/F 1050 are electrically connected to the ASIC 1005 via the PCI bus 1022.

(Hardware Configuration of Information Processing Server)

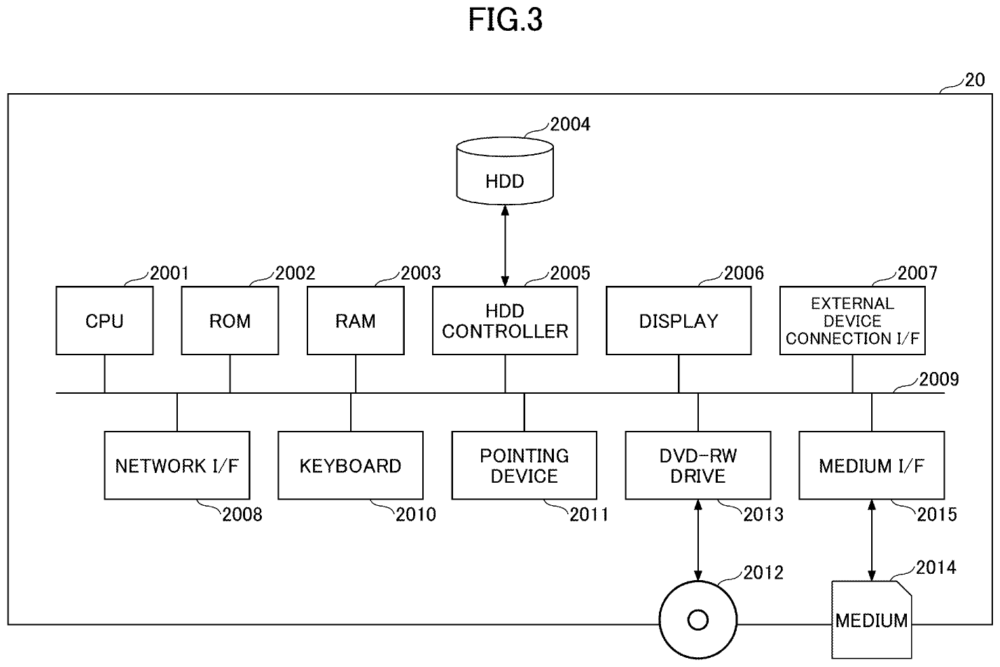

FIG. 3 is a diagram illustrating a hardware configuration of the information processing server 20 according to the embodiment of the present disclosure.

As illustrated in FIG. 3, the information processing server 20 is constituted by a computer, and as illustrated in FIG. 3, the information processing server 20 includes a central processing unit (CPU) 2001, a read-only memory (ROM) 2002, a random access memory (RAM) 2003, a hard disk drive (HDD) 2004, an HDD controller 2005, a display 2006, an external device connection interface (I/F) 2007, a network I/F 2008, a data bus 2009, a keyboard 2010, a pointing device 2011, a Digital Versatile Disc Rewritable (DVD-RW) drive 2013, and a medium interface 2015.

Among them, the CPU 2001 controls the overall operation of the information processing server 20. The ROM 2002 stores programs used for driving the CPU 2001, such as an IPL. The RAM 2003 is used as a work area for the CPU 2001. The HDD 2004 stores various kinds of data such as programs. The HDD controller 2005 controls reading or writing of various kinds of data from or to the HDD 2004 according to the control of the CPU 2001. The display 2006 displays various kinds of information such as a cursor, menus, windows, characters, or images. The external device connection I/F 2007 is an interface for connecting various kinds of external devices. In this case, the external device is, for example, a universal serial bus (USB) memory and a printer. The network I/F 2008 is an interface for performing data communication using the communication network. The data bus 2009 is, for example, an address bus, a data bus, and the like for electrically connecting constituent elements such as the CPU 2001 as illustrated in FIG. 3.

The keyboard 2010 is a type of input means having a plurality of keys for inputting characters, numerical values, various instructions, and the like. The pointing device 2011 is a type of input means for selecting and executing various instructions, selecting a processing target, moving a cursor, and the like. The DVD-RW drive 2013 controls reading or writing of various kinds of data from or to a DVD-RW 2012 as an example of a removable recording medium. It should be noted that the removable recording medium is not limited to the DVD-RW, and may be a DVD-R or the like. The medium I/F 2015 controls reading or writing (storing) of data from or to a recording medium 2014 such as a flash memory.

(Functional Blocks of Information Process System)

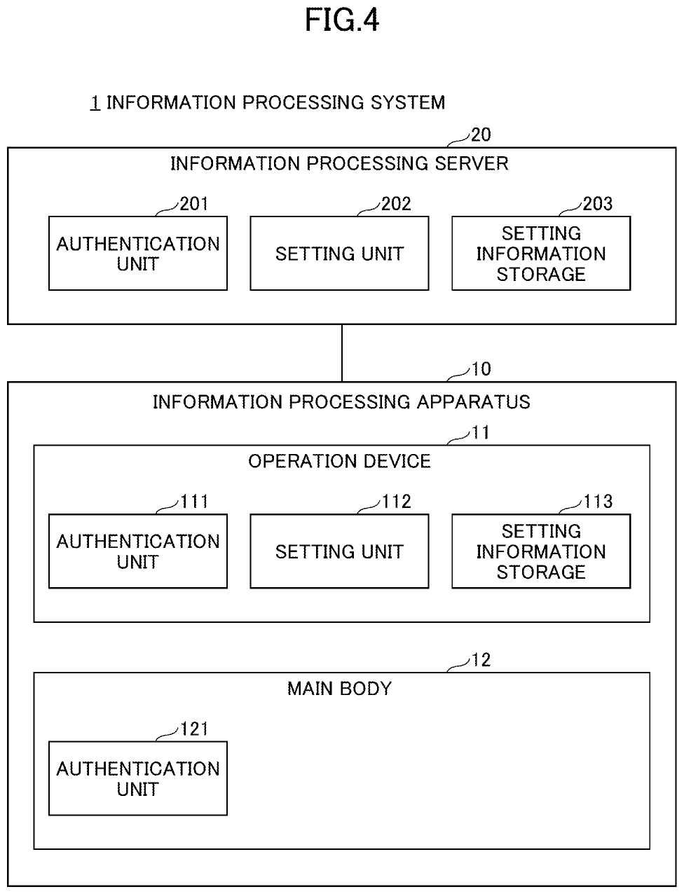

FIG. 4 illustrates functional blocks of the information processing system 1 according to the embodiment of the present disclosure.

(Functional Block of Information Processing Apparatus (Operation Device))

The operation device 11 of the information processing apparatus 10 includes an authentication unit 111, a setting unit 112, and a setting information storage 113. Further, the operation device 11 of the information processing apparatus 10 functions as the authentication unit 111 and the setting unit 112 by executing a program.

The authentication unit 111 provides a login function (that is, logging in to the information processing apparatus 10 can be performed by using account information of a cloud service) for a user of a cloud service provided by the information processing server 20 to log in to the information processing apparatus 10.

Specifically, the authentication unit 111 provides a user interface (UI) for inputting account information with respect to a user and requests the information processing server 20 to authenticate the user, based on account information that is input. In a case where the information processing server 20 is not usable by the information processing apparatus 10, the authentication unit 111 logs in a user as a guest user. The authentication unit 111 requests processing of logging in to the information processing apparatus 10 with respect to the main body 12, based on results of the authentication.

The setting unit 112 acquires, from the information processing server 20, information as to whether guest user login is enabled or disabled and information as to whether use-permission of the respective functions of the information processing apparatus 10 of the guest user is enabled or disabled, and stores the acquired information into the setting information storage 113.

The setting information storage 113 stores therein the setting information. The setting information is information as to whether guest user login is enabled or disabled and information as to whether use-permission of the respective functions of the information processing apparatus 10 of the guest user is enabled or disabled. For example, the setting information includes information as to whether use-permission of a copy function, a printer function, a scanner function, a facsimile function, and a document server function of the information processing apparatus 10 of the guest user is enabled or disabled. The setting information may also include detailed setting values (for example, as to whether color is enabled or disabled, as to whether monochrome is enabled or disabled, and so on) for the respective functions in addition to the information as to whether use-permission of the respective functions is enabled or disabled.

(Functional Block of Information Processing Apparatus (Main Body))

The main body 12 of the information processing apparatus 10 includes an authentication unit 121. Further, the main body 12 of the information processing apparatus 10 functions as the authentication unit 121 by executing a program.

The authentication unit 121 manages the logged-in and logged-out states of the information processing apparatus 10. Specifically, the authentication unit 121 receives a login processing request from the operation device 11 and changes the state of the information processing apparatus 10 to a logged in state (state in which the user can use the function of the information processing apparatus 10) or to a logged out state (state in which the user cannot use the function of the information processing apparatus 10).

(Functional Block of Information Processing Server)

The information processing server 20 includes an authentication unit 201, a setting unit 202, and a setting information storage 203. Also, the information processing server 20 functions as the authentication unit 201 and the setting unit 202 by executing a program.

The authentication unit 201 authenticates a user logging in to the information processing apparatus 10. Specifically, the authentication unit 201 provides a user authentication application programming interface (API) and manages user information (account information and use-permission of the information processing apparatus 10).

The setting unit 202 sets whether guest user login is enabled or disabled and sets whether use-permission of the respective functions of the information processing apparatus 10 of the guest user is enabled or disabled. Specifically, the setting unit 202 stores information as to whether guest user login is enabled or disabled based on instructions of an administrator of the information processing apparatus 10 into the setting information storage 203. Further, the setting unit 202 stores information as to whether use-permission of the respective functions of the information processing apparatus 10 of the guest user is enabled or disabled based on instructions of the administrator of the information processing apparatus 10 into the setting information storage 203.

The setting unit 202 also sets whether use-permission of the respective functions of the information processing apparatus 10 is enabled or disabled for not only the guest user but also for each of the users.

The setting information storage 203 stores therein the setting information. The setting information is information as to whether guest-based login is enabled or disabled and information as to whether use-permission of the respective functions of the information processing apparatus 10 of the guest user is enabled or disabled. For example, the setting information includes information as to whether the use-permission of the copy function, the printer function, the scanner function, the facsimile function, and the document server function of the information processing apparatus 10 of the guest user is enabled or disabled. The setting information may include not only information as to whether use-permission of the respective functions is enabled or disabled but also detailed setting values (for example, as to whether color is enabled or disabled, as to whether monochrome is enabled or disabled, and so on) for the respective functions.

The setting information storage 203 stores information as to whether use-permission of the respective functions of the information processing apparatus 10 is enabled or disabled for not only the guest user but also for each of the users.

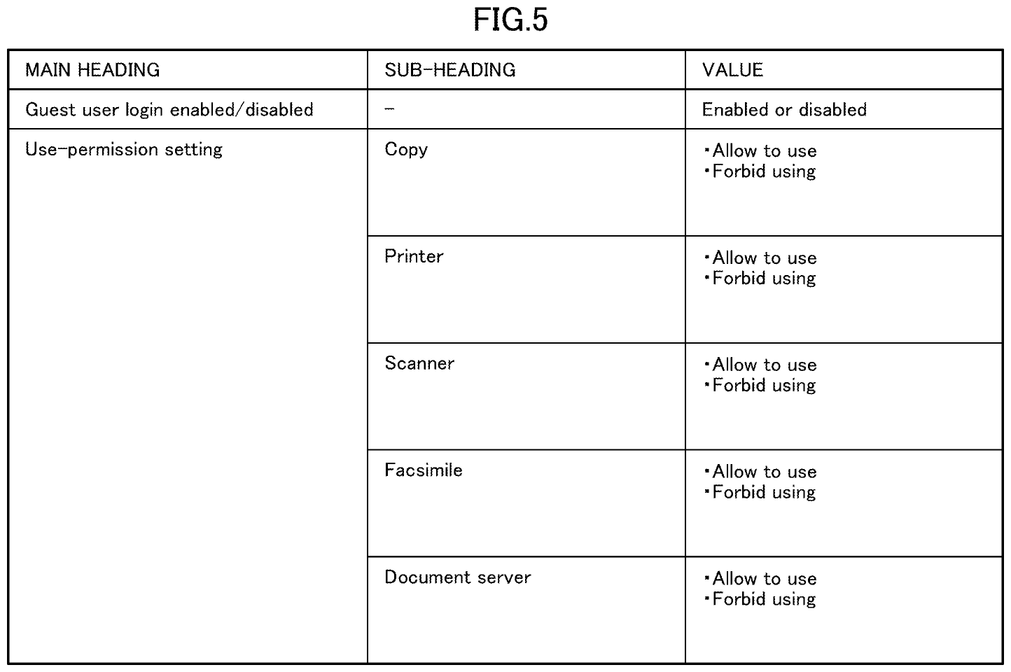

FIG. 5 is an example of the setting information according to the embodiment of the present disclosure. The setting information storage 203 of the information processing server 20 and the setting information storage 113 of the operation device 11 of the information processing apparatus 10 can each store therein the setting information of FIG. 5.

The setting information is information as to whether guest user login is enabled or disabled and information as to whether use-permission of the respective functions of the information processing apparatus 10 of the guest user is enabled or disabled. For example, the setting information includes information as to whether use-permission of the copy function, the printer function, the scanner function, the facsimile function, and the document server function of the information processing apparatus 10 of the guest user is enabled or disabled. For example, the setting information may include not only information as to whether use-permission of the respective functions is enabled or disabled but also detailed setting values (for example, as to whether color is enabled or disabled, as to whether monochrome is enabled or disabled, and so on) of the respective functions.

(Processing Method)

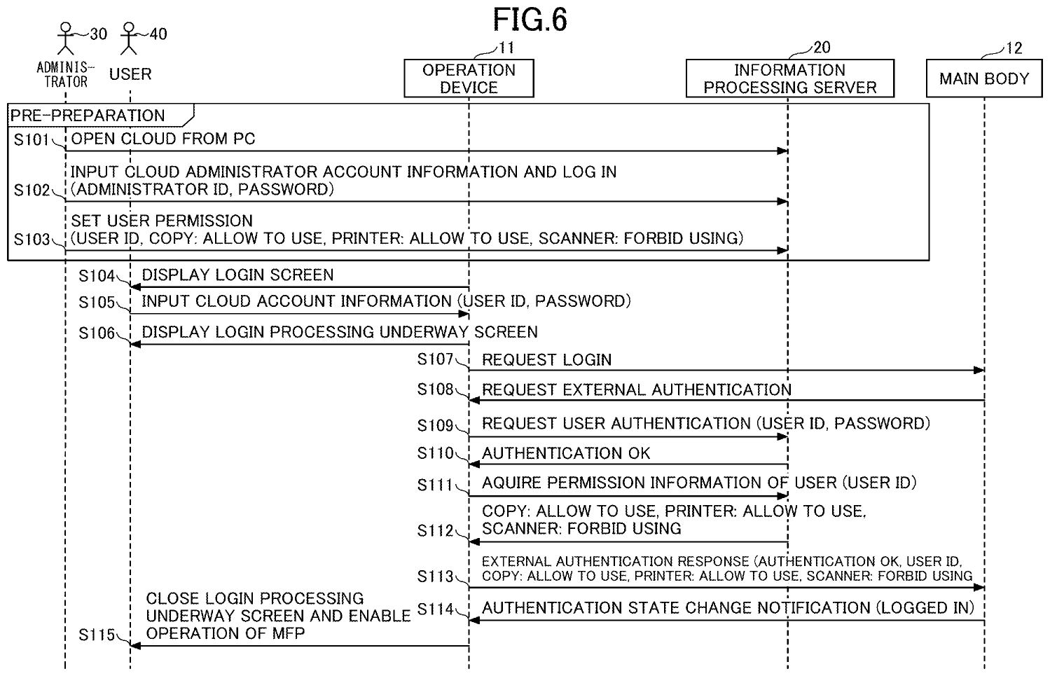

FIG. 6 is a sequence diagram illustrating a processing flow in a case where the information processing server 20 is usable according to the embodiment of the present disclosure.

S101 to S103 represent the pre-preparation that is to be performed by an administrator 30 of the information processing apparatus 10.

In step 101 (S101), the administrator 30 accesses a website (website of a cloud service, for example) provided by the information processing server 20 from the web browser of a personal computer (PC) or the like.

In step 102 (S102), the administrator 30 logs in by inputting account information (administrator ID and password) of the administrator 30.

In step 103 (S103), the administrator 30 accesses the user management webpage and sets use-permission of the information processing apparatus 10 of each user. For example, it is assumed that the administrator 30 set permission of the copy function to granted (Allow to use), set permission of the printer function to granted (Allow to use), and set permission of the scanner function to not granted (Forbid using), with respect to a user 40.

S104 and beyond represent operations performed by the user 40 when logging in to the information processing apparatus 10.

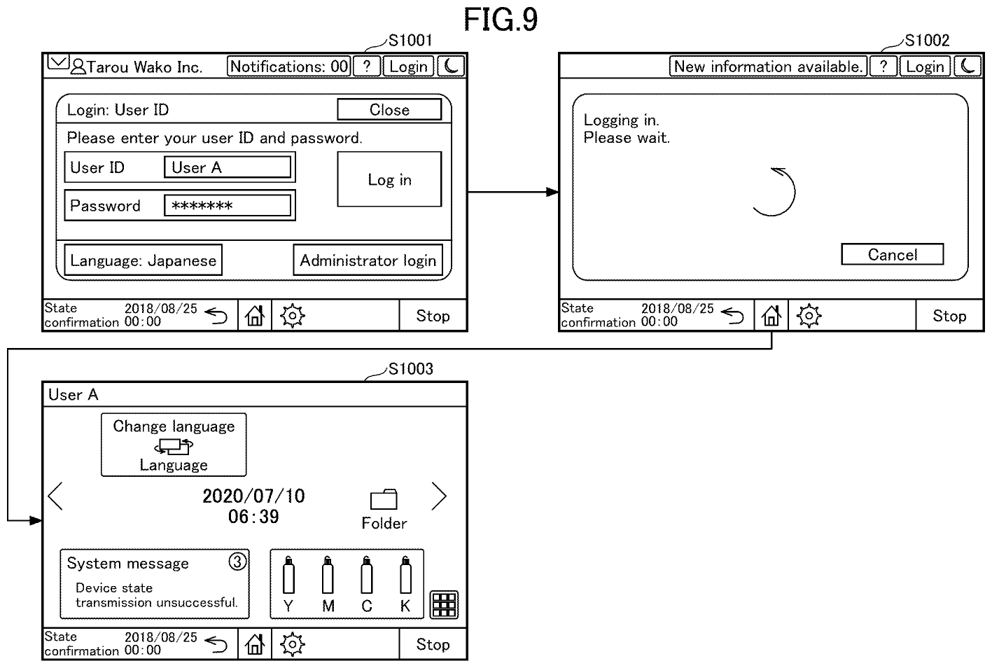

In step 104 (S104), the operation device 11 of the information processing apparatus 10 displays a login screen (S1001 of FIG. 9 described further below) with respect to the user 40.

In step 105 (S105), the user 40 inputs his/her own account information (user ID and password) via the login screen.

In step 106 (S106), the operation device 11 displays a login processing underway screen (S1002 of FIG. 9 described further below).

In step 107 (S107), the operation device 11 notifies the main body 12 of the information processing apparatus 10 that login processing has begun.

In step 108 (S108), the main body 12 makes a request to the operation device 11 to perform login processing by the information processing server 20.

In step 109 (S109), the operation device 11 requests authentication to the information processing server 20 together with the account information (user ID and password) input in S105.

In step 110 (S110), the information processing server 20 performs authentication of the user 40 and sends the authentication result of the user 40 to the operation device 11 in return.

In step 111 (S111), the operation device 11 requests the information processing server 20 to acquire information of use-permission of the user 40, together with the user ID input in S105.

In step 112 (S112), the information processing server 20 sends use-permission (that is, the values set by the administrator 30 in S101 to S103) of the respective functions of the information processing apparatus 10 of the user 40 for which setting was performed to the operation device 11 in return.

In step 113 (S113), the operation device 11 notifies the main body 12 regarding the authentication results and use-permission of the respective functions of the information processing apparatus 10 of the user 40.

In step 114 (S114), the main body 12 sets whether the use-permission of the functions is enabled or disabled in accordance with the use-permission of the respective functions of the information processing apparatus 10 of the user 40 (in the example of FIG. 6, that the copy function is allowed to be used, the printer function is allowed to be used, and the scanner function is forbidden to be used) and notifies the operation device 11 that the information processing apparatus 10 is in a logged-in state.

In step 115 (S115), the operation device 11 closes the login processing underway screen and enables operation of the information processing apparatus 10 (displays S1003 of FIG. 9 which is described further below).

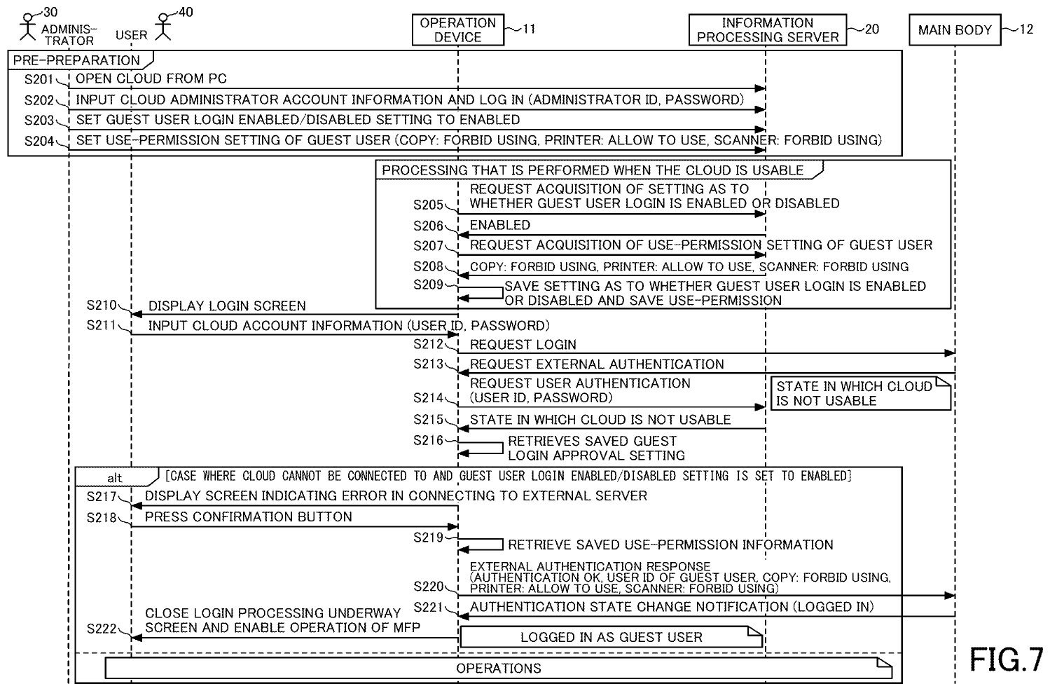

FIG. 7 is a sequence diagram illustrating a processing flow in a case where the information processing server 20 according to the embodiment is not usable.

S201 to S204 represent the pre-preparation that is to be performed by the administrator 30 of the information processing apparatus 10.

In step 201 (S201), the administrator 30 accesses the website (website of the cloud service, for example) provided by the information processing server 20 from the web browser of the personal computer (PC) or the like.

In step 202 (S202), the administrator 30 logs in by inputting account information (administrator ID and password) of the administrator 30.

In step 203 (S203), the administrator 30 sets the guest user login enabled/disabled to “enabled”. The setting unit 202 of the information processing server 20 stores the information as to whether guest user login is enabled or disabled into the setting information storage 203.

In step 204 (S204), the administrator 30 accesses the user management webpage and sets use-permission of the information processing apparatus 10 of the guest user. The setting unit 202 of the information processing server 20 stores the information as to whether use-permission of the respective functions of the information processing apparatus 10 of the guest user is enabled or disabled into the setting information storage 203. For example, it is assumed that the administrator 30 set permission of the copy function to not granted (Forbid using), set permission of the printer function to granted (Allow to use), and set permission of the scanner function to not granted (Forbid using).

S205 to S209 represent processing performed by the operation device 11 of the information processing apparatus 10 at any timing during which the operation device 11 is usable.

In step 205 (S205), the operation device 11 (setting unit 112), requests to the information processing server 20 (setting unit 202) to acquire information as to whether guest user login is enabled or disabled.

In step 206 (S206), the information processing server 20 (setting unit 202) sends a setting value indicating whether guest user login is enabled or disabled in return. In the example of FIG. 7, the information processing server 20 (setting unit 202) sends, in accordance with the setting of S203, a setting value of “enabled” to the operation device 11 (setting unit 112) in return.

In step 207 (S207), the operation device 11 (setting unit 112) requests to the information processing server 20 (setting unit 202) to acquire information regarding use-permission of the guest user.

In step 208 (S208), the information processing server 20 (setting unit 202) sends the setting value regarding use-permission of the guest user in return. In the example of FIG. 7, the information processing server (setting unit 202) sends to the operation device 11 (setting unit 112), in accordance with the setting of S204. the settings values of “no permission granted for the copy function”, “permission granted for the printer function”, and no permission granted for the scanner function in return.

In step 209 (S209), the operation device 11 (setting unit 112) stores the information as to whether the guest user login is enabled or disabled and information as to whether use-permission of the respective functions of the information processing apparatus 10 of the guest user is enabled or disabled, into the setting information storage 113.

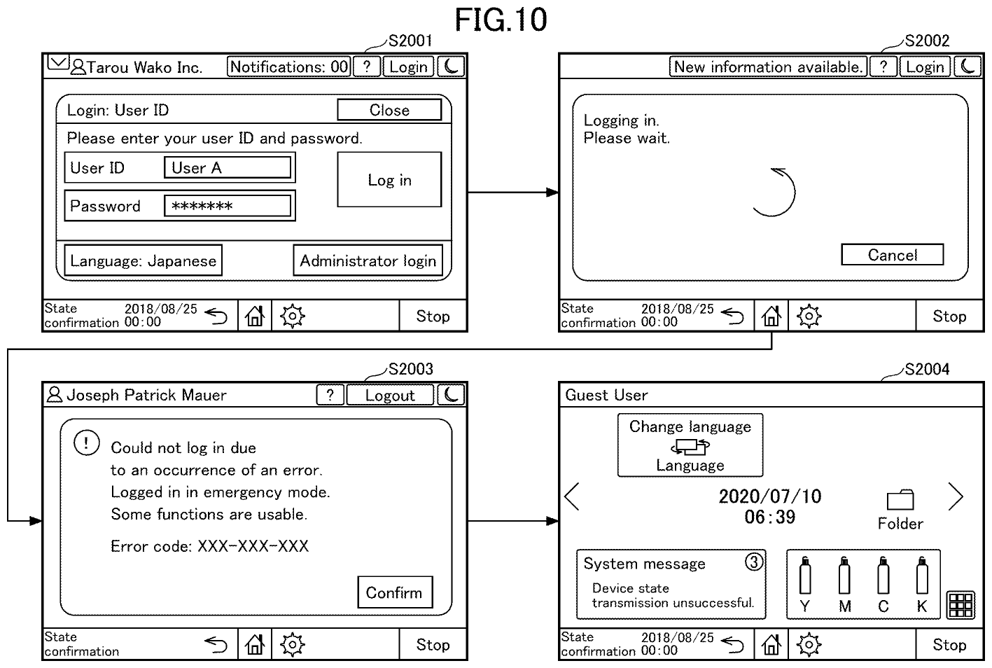

In step 210 (S210), the operation device 11 (authentication unit 111) displays a login screen (S2001 of FIG. 10 which is described further below) for the user 40.

In step 211 (S211), the user 40 inputs his/her account information (user ID and password).

In step 212 (S212), the operation device 11 (authentication unit 111) notifies the main body 12 of the information processing apparatus 10 that login processing has begun.

In step 213 (S213), the main body 12 (authentication unit 121) makes a request to the operation device 11 (authentication unit 111) to perform login processing by the information processing server 20.

In step 214 (S214), the operation device 11 (authentication unit 111) requests authentication to the information processing server 20 (authentication unit 201) together with the account information (user ID and password) input in S211.

In step 215 (S215), it is assumed that the information processing server 20 was not usable by the information processing apparatus 10 due to there being no network connection between the information processing apparatus 10 and the information processing server 20, due to the information processing server 20 being down, or the like.

In step 216 (S216), the operation device 11 (authentication unit 111) reads out the information, stored in the setting information storage 113 in S209, as to whether guest user login is enabled or disabled.

In step 217 (S217), the operation device 11 (authentication unit 111) displays an error screen (switches from S2002 to S2003 of FIG. 10 described further below) in a case where the information processing server 20 is in a state of not being usable by the information processing apparatus 10 and guest user login is set to “enabled”.

In step 218 (S218), the user 40 presses the confirmation button on the error screen.

In step 219 (S219), the operation device 11 (authentication unit 111) reads out the information, stored in the setting information storage 113 in S209, as to whether use-permission of the respective functions of the information processing apparatus 10 of the guest user is enabled or disabled.

In step 220 (S220), the operation device 11 (authentication unit 111) notifies the main body 12 (authentication unit 121) of the authentication results and of use-permission of the respective functions of the information processing apparatus 10 of the guest user.

In the 221 (S221), the main body 12 (authentication unit 121) sets whether the use-permission of the functions is enabled or disabled in accordance with the use-permission of the respective functions of the information processing apparatus 10 of the guest user (in the example of FIG. 7, that the copy function is forbidden to be used, the printer function is allowed to be used, and the scanner function is forbidden to be used) and notifies the operation device 11 (authentication unit 111) that the information processing apparatus 10 is in a logged-in state.

In step 222 (S222), the operation device 11 (authentication unit 111) closes the login screen and enables operation of the information processing apparatus (displays 51004 of FIG. 10 which is described further below).

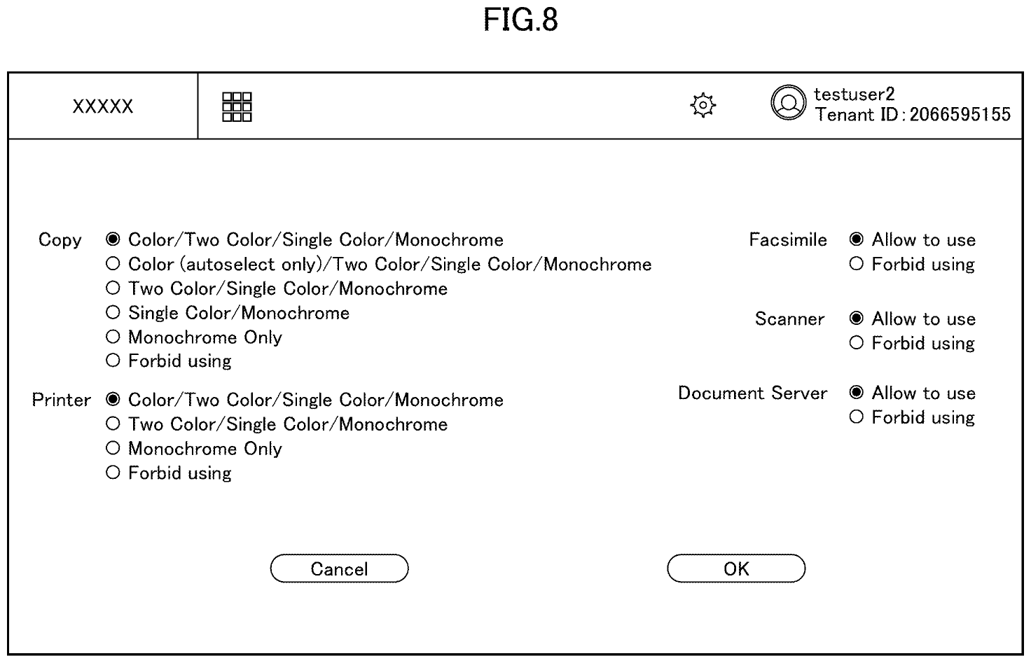

FIG. 8 is an example of a setting screen according to the embodiment of the present disclosure. The personal computer (PC), or the like of the administrator of the information processing apparatus 10 can display the screen of FIG. 8. The administrator can set use-permission of the respective functions of the information processing apparatus 10 of the guest user and can set use-permission of the respective functions of the information processing apparatus 10 of each user from the setting screen.

For example, the administrator can set whether or not use-permission of the copy function, the printer function, the scanner function, facsimile function, and the document server function of the information processing apparatus 10 of the guest user and each user is enabled or disabled. Settings may be configured such that detailed setting values (for example, as to whether color is enabled or disabled, as to whether monochrome is enabled or disabled, and so on) for the respective functions in addition to the information as to whether use-permission of the respective functions is enabled or disabled.

FIG. 9 is an example of a screen in a case where the information processing server 20 according to the embodiment of the present disclosure is usable. The operation device 11 of the information processing apparatus 10 can display screens S1001 to S1003 of FIG. 9.

In step 1001 (S1001), the operation device 11 displays a login screen. The user inputs account information (user ID and password). Upon pressing of the login button by the user, processing proceeds to step 1002.

In step 1002 (S1002), the operation device 11 displays the login processing underway screen.

In step 1003 (S1003), the operation device 11 displays a home screen indicating that the information processing apparatus 10 is in a state of being usable. S1003 indicates that the user is logged in as user A (that is, not a guest user). At this time, the information processing apparatus 10 is usable under the permission that is assigned to user A.

FIG. 10 is an example of a screen in a case where the information processing server 20 according to the embodiment of the present disclosure is not usable. The operation device 11 of the information processing apparatus 10 can display screens S2001 to S2004 of FIG. 10.

In step 2001 (S2001), the operation device 11 displays the login screen. The user inputs account information (user ID and password). Upon pressing of the login button by the user, processing proceeds to step 2002.

In step 2002 (S2002), the operation device 11 displays the login processing underway screen. At this time, it is assumed that the information processing server 20 was not usable by the information processing apparatus 10 due to there being no network connection between the information processing apparatus 10 and the information processing server 20, due to the information processing server 20 being down, or the like.

In step 2003 (S2003), the operation device 11 displays a screen indicating an error and that login is being performed in emergency mode (that is, logging in as a guest user). Upon pressing of the login button by the user, processing proceeds to step 2004.

In step 2004 (S2004), the operation device 11 displays a home screen indicating that the information processing apparatus 10 is in a state of being usable. S2004 indicates that the user is logged in as a guest user. At this time, the information processing apparatus 10 is usable under the permission that is assigned to a guest user.

### Effect

As described in the embodiment of the present disclosure, the user can log in to the information processing apparatus 10 even when the information processing server 20 is not usable by the information processing apparatus 10. That is, the user can use the information processing apparatus 10 even if there is no network connection between the information processing apparatus 10 and the information processing server 20, the information processing server 20 is down, and so on.

The respective functions of the embodiment described above can be implemented by one or a plurality of processing circuits. Here, it is assumed that “processing circuit” in this specification is considered to include a processor programmed to execute the functions by software, such as a processor implemented by an electronic circuit, and devices designed to execute the respective functions described above, such as an Application Specific Integrated Circuit (ASIC), a Digital Signal Processor (DSP), Field Programmable Gate Array (FPGA), and conventional circuit modules.

Although the embodiment has been hereinabove described in detail, the present disclosure is not limited to such a specific embodiment, and various modifications and changes can be made within the subject matter described in the claims.

In the embodiment of the present disclosure, a user can log in to the information processing apparatus when the authentication server is not usable by the information processing apparatus.

### REFERENCE SIGNS LIST

1 Information processing system
10 Information processing apparatus
11 Operation device
12 Main body
20 Information processing server
111 Authentication unit
112 Setting unit
113 Setting information storage
121 Authentication unit
201 Authentication unit
202 Setting unit
203 Information storage

What is claimed is:

1. An information processing system, comprising:
an information processing apparatus including a first processor and a first memory storing first program instructions; and
an information processing server including a second processor and a second memory storing second program instructions that cause the second processor to authenticate a user logging in to the information processing apparatus,
wherein the first program instructions cause the first processor to log in the user as a guest user when the information processing server is not usable by the information processing apparatus.

2. The information processing system according to claim 1, wherein the second program instructions further cause the second processor to set a login of the guest user to enabled or disabled.

3. The information processing system according to claim 2, wherein the second program instructions further cause use-permission of respective functions of the information processing apparatus of the guest user to be set to enabled or disabled.

4. The information processing system according to claim 1, wherein the guest user is an account common to all users and usable by all the users.

5. A non-transitory computer-readable recording medium having stored therein program instructions for causing a processor of an information processing apparatus to log in a user as a guest user when an information processing server configured to authenticate a user logging in to the information processing apparatus is not usable.

6. A method to be executed by an information processing apparatus, the method comprising:
logging in a user as a guest user when an information processing server configured to authenticate a user logging in to the information processing apparatus is not usable.
